(19) United States
(12) Patent Application Publication
(10) Pub. No.: US 2013/0049914 A1
(43) Pub. Date: Feb. 28, 2013

(54) SURFACE MOUNTED PULSE TRANSFORMER

(71) Applicants: LUN-TSU HUANG, New Taipei (TW); CAI-GANG XU, Kunshan (CN); ZHI LU, Kunshan (CN)

(72) Inventors: LUN-TSU HUANG, New Taipei (TW); CAI-GANG XU, Kunshan (CN); ZHI LU, Kunshan (CN)

(73) Assignee: HON HAI PRECISION INDUSTRY CO., LTD., New Taipei (TW)

(21) Appl. No.: 13/591,252

(22) Filed: Aug. 22, 2012

(30) Foreign Application Priority Data
Aug. 22, 2011 (CN) 201120304774.5
May 21, 2012 (CN) 201220227780.X
Jul. 6, 2012 (CN) 201220325703.8

(51) Int. Cl. H01F 27/29

(52) U.S. Cl. 336/192

(57) ABSTRACT

A surface mounted pulse transformer (100) comprising a drum core (1) and a number of coils (3). The drum core includes a core (11), a first flange (12a) and a second flange (12b) disposed on both ends of the core. The number of coils wind around the core to form a primary coil and a secondary coil. A number of electrodes (40) are formed on surfaces of the first and second flanges and to be connected to an external substrate. The ends of the coils are physically and electrically connected to the electrodes. One of the electrodes has an electrode groove (401) for receiving and positioning one end of the coils.

### BACKGROUND OF THE INVENTION

1. Field of the Invention

The present invention relates to a surface mounted pulse transformer.

2. Description of Related Art

U.S. Pat. No. 8,093,980 discloses a surface mounted pulse transformer including a drum type core and a plurality of coils. The drum type core includes a core, a first flange and a second flange disposed on both ends of the core. The plurality of coils wind around the core to form a primary coil and a secondary coil. A plurality of electrodes are formed on surfaces of the first and second flanges and to be connected to an external substrate. The ends of the coils are physically and electrically connected to the electrodes. The electrodes are disposed as plane pads, therefore the ends of the coils are difficult to be positioned and soldered.

U.S. Pat. No. 7,256,673 discloses a common-mode choke coil including a core, first and second conducting wires, and first and second electrode parts. The core includes a winding section and first and second flanges on either end of the core. Each flange has a front surface and a top surface. A pair of grooves are formed in the top surface sloping from a central position on the top surface in a direction toward the winding section. Each electrode part includes a first electrode on one side of the flange and a second electrode on the opposite side of the flange formed by electroplating either side of the top surface of the front surface. A portion of the electrode is, therefore, formed in the groove in the top surface. The top surface portion of the electrode part is the part that connects with conducting traces on external substrate.

### SUMMARY OF THE INVENTION

Accordingly, an object of the present invention is to provide a surface mounted pulse transformer could easily position the coils.

In order to achieve the object set forth, the invention provides a surface mounted pulse transformer comprising a drum core and a plurality of coils. The drum core includes a core, a first flange and a second flange disposed on both ends of the core. The plurality of coils wind around the core to form a primary coil and a secondary coil. A plurality of electrodes are formed on surfaces of the first and second flanges and to be connected to a substrate. The ends of the coils are physically and electrically connected to the electrodes. One of the electrodes has an electrode groove for receiving and positioning one end of the coils.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a surface mounted pulse transformer in accordance with a first embodiment of the present invention;

FIG. 2 is plane exploded view of the surface mounted pulse transformer shown in FIG. 1, with electrodes being omitted;

FIG. 3 is an exploded view of a surface mounted pulse transformer shown in FIG. 1, with electrodes being omitted;

FIG. 4 is a view showing the arrangement of the surface mounted pulse transformer shown in FIG. 3;

FIG. 5 is a view showing an equivalent circuit of the surface mount pulse transformer shown in FIG. 3; and

FIG. 6 is a perspective view of a surface mounted pulse transformer in accordance with a second embodiment of the present invention.

### DETAILED DESCRIPTION OF THE PREFERRED EMBODIMENT

Reference will now be made in detail to the preferred embodiment of the present invention.

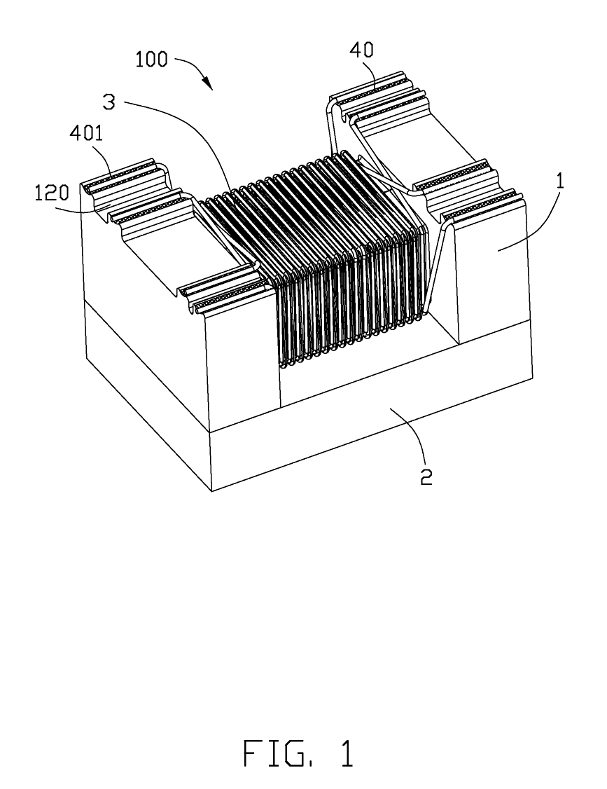

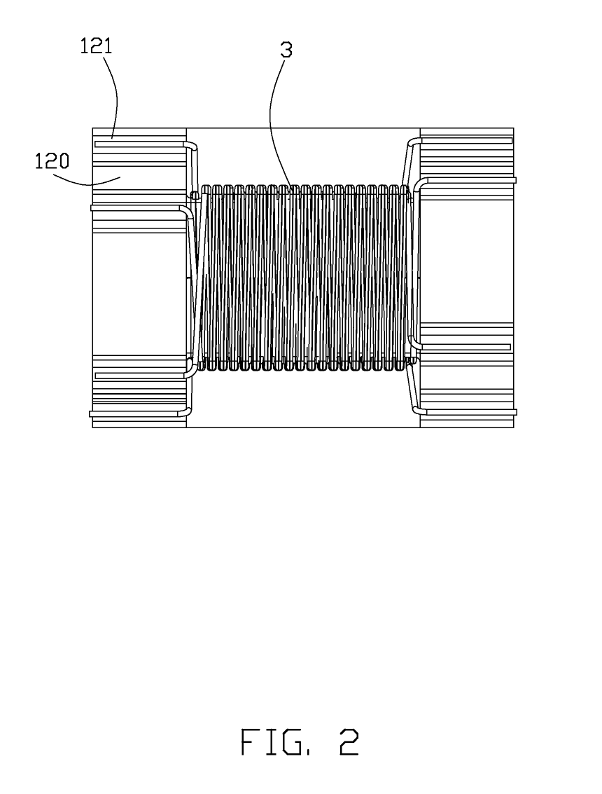

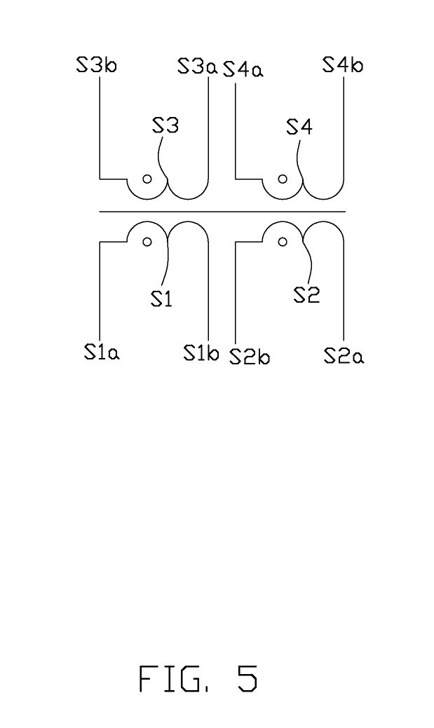

Referring to FIGS. 1-3, a surface mounted pulse transformer 100 according to a first embodiment of the present invention. The surface mounted pulse transformer 100 could be mounted to an external substrate. The surface mounted pulse transformer 100 includes a drum core 1, a lid 2 and a plurality of coils 3. The drum core 1 includes a core 11, a first flange 12a and a second flange 12b disposed on both ends of the core 11. The coils 3 wind around the core 11 to form a primary coil and a secondary coil (FIG. 5).

A plurality of electrodes 40 are formed on surfaces of the first and second flanges 12a, 12b and to be connected to the external substrate. The first flange 12a has four electrodes 40 each having an electrode groove 401 and three recesses 120 each disposed between two electrodes 40. A lower wall of each recess 120 protrudes outwardly from the core 11. The first flange 12a has four slots 121 for the electrodes 40 attaching to form the electrode grooves 401. The radius of the electrode groove 401 is greater than the radius of each coil 3. The second flange 12b is disposed same as the first flange 12a.

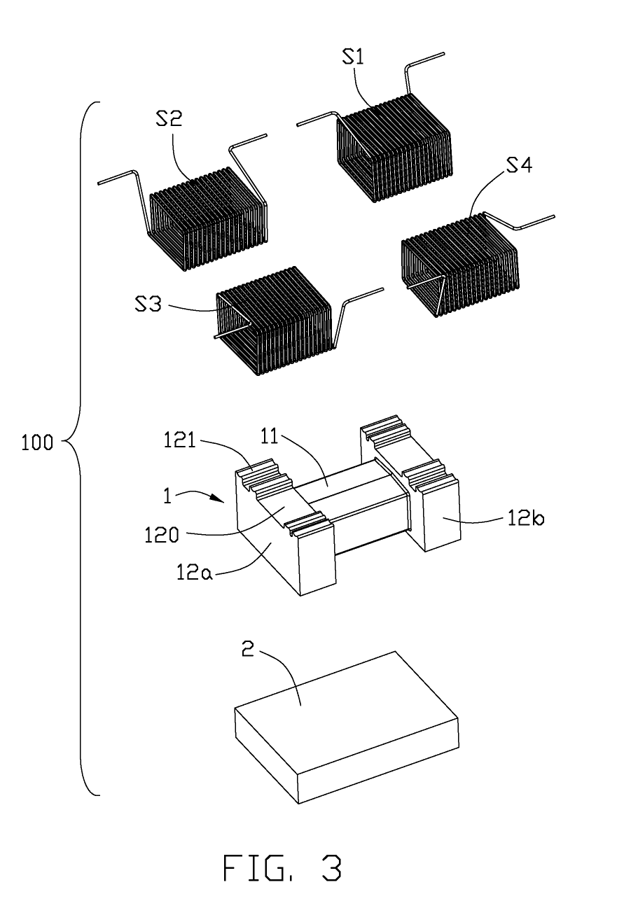

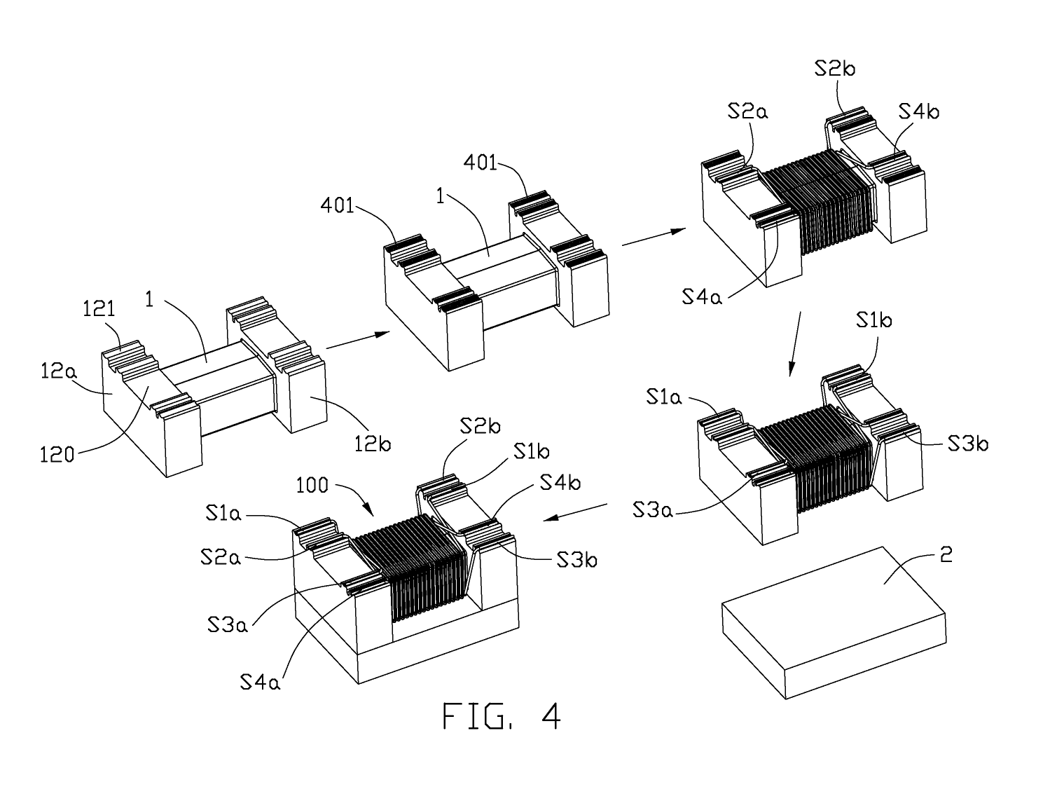

Referring to FIGS. 3-4, the plurality of coils 3 comprise a first coil S1, a second coil S2, a third coil S3, and a fourth coil S4 each having a first end S1a, S2a, S3a, S4a and a second end S1b, S2b, S3b, S4b. The slots 121 of the first and second flanges 12a, 12b are electroplated to form the electrode grooves 401. The second coil S2 and the fourth coil S4 are wind from the first flange 12a to the second flange 12b along a clockwise direction. The first coil S1 and the third coil S3 are wind from the first flange 12a to the second flange 12b along a counterclockwise direction. Four first ends S1a, S2a, S3a, S4a are respectively receiving and positioning in the electrode grooves 401 of the first flange 12a. Four second ends S1b, S2b, S3b, S4b are respectively receiving and positioning in the electrode grooves 401 of the second flange 12b. Then, the first and second ends of the coils are physically and electrically connected to the electrodes through hot-melt welding, or they are thermo-compression bonded. The lid 2 is assembled to the drum core 1. The first end S2a of the second coil S2 crosses the first end S3a of the third coil S3. The second end S4b of the fourth coil S4 crosses the second end S1b of the first coil S1.

As shown in FIG. 5, the first and second coils S1, S2 form the primary coil, and the third and fourth coils S3, S4 form the secondary coil.

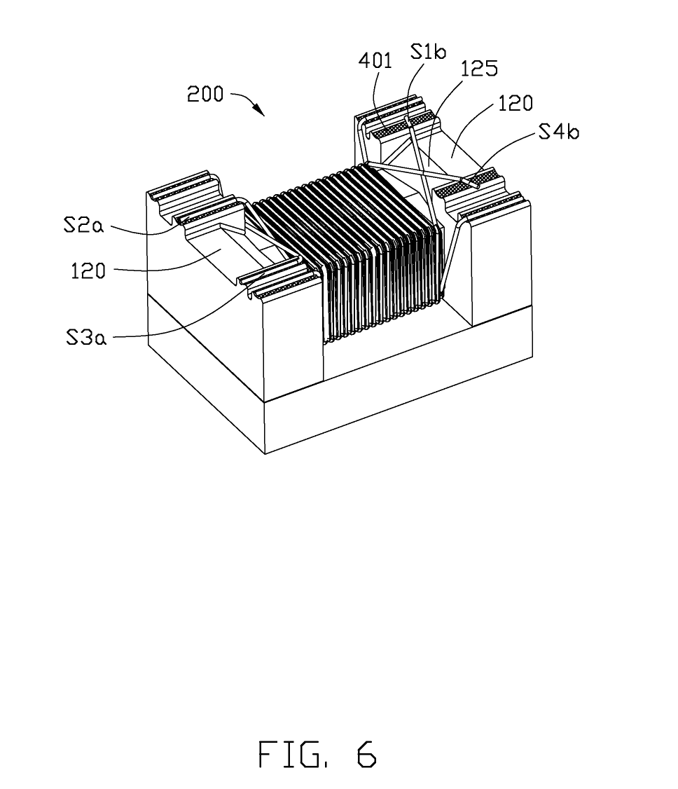

Referring to FIG. 6, a surface mounted pulse transformer 200 according to a second embodiment of the present invention. There are several variations compared to the first embodiment as detailed below.

Two second ends S1b, S4b are respectively connected to two electrode grooves 401 of the second flange 12b with certain angle. A lower wall of the recess 120 has a hollow part 125. Compared to the first embodiment, the winding process is made easier and the second ends S1b, S4b cross each other while keeping a distance therebetween due to the hollow part 125. Two first ends S2a, S3a are hanged in one recess 120 of the first flange 12a for avoiding touching an edge of the first flange 12a. Two second ends S1b, S4b are hanged in one recess 120 of the second flange 12b for avoiding touching an edge of the second flange 12b.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. A surface mounted pulse transformer, comprising:
a drum core including a core, a first flange and a second flange disposed on both ends of the core;
a plurality of coils winding around the core to form a primary coil and a secondary coil; and
a plurality of electrodes formed on surfaces of the first and second flanges and to be connected to an external substrate, the ends of the coils being physically and electrically connected to the electrodes;
wherein one of the electrodes defines an electrode groove for receiving and positioning one end of the coils.

2. The surface mounted pulse transformer as claimed in claim 1, wherein said first flange has a plurality of recesses, each of the recesses disposed between two electrodes.

3. The surface mounted pulse transformer as claimed in claim 2, wherein said coils has two coils crossing with each other and then respectively soldering to the electrodes of the first flange, the crossing coils being hanged in one recess of the first flange for avoiding touching an edge of the first flange.

4. The surface mounted pulse transformer as claimed in claim 1, wherein said first flange has a slot, one of the electrodes attached to the slot to form the electrode groove.

5. The surface mounted pulse transformer as claimed in claim 1, wherein the radius of the electrode groove is greater than the radius of each coil.

6. The surface mounted pulse transformer as claimed in claim 1, wherein the first flange has four electrode grooves, the coils has four first ends respectively receiving and positioning in the electrode grooves.

7. The surface mounted pulse transformer as claimed in claim 1, wherein the second flange has four electrode grooves, the coils having two second ends respectively receiving and positioning in two electrode grooves and other two second ends respectively connecting to two other electrode grooves with certain angle.

8. The surface mounted pulse transformer as claimed in claim 7, wherein the other two ends cross each other and have a distance therebetween.

9. The surface mounted pulse transformer as claimed in claim 1, wherein a lower wall of each recess protrudes from the core.

10. The surface mounted pulse transformer as claimed in claim 1, wherein a lower wall of one recess has a hollow part for the crossing coil being hanged in.

11. A surface mounted pulse transformer, comprising:
a drum core including a core, a first flange and a second flange disposed on different positions of the core;
a plurality of coils winding around the core to form a primary coil and a secondary coil; and
a plurality of electrodes formed on surfaces of the first and second flanges to be connected to an external substrate, the ends of the coils being physically and electrically connected to the electrodes, respectively;
wherein one of the electrodes defines an electrode groove to receive and position one end of one of the coils therein.

12. The surface mounted pulse transformer as claimed in claim 11, wherien the drum corer further defines, around one of said positions, a recess with thereon a oblique surface against which a portion of said one of the coils adjacent to said one end abuts.

13. The surface mounted pulse transformer as claimed in claim 11, wherein said electrode groove extends along an axial direction of the core.

14. The surface mounted pulse transformer as claimed in claim 11, wherein the one end of said one of the coils is compliantly and essentially fully embedded in the electrode groove.

15. The surface mounted pulse transformer as claimed in claim 11, wherein the one end of said one of the coils is received in the electrode groove in an intersecting manner.

16. The surface mounted pulse transformer as claimed in claim 11, wherein all the electrodes are equipped with corresponding electrode grooves to receive the corresponding ends of the coils.

17. The surface mounted pulse transformer as claimed in claim 11, wherein said coils include four coils each having two opposite ends respectively fastened to the corresponding electrodes, and two of said four coils are primary coils while the other two are secondary coils.

18. The surface mounted pulse transformer as claimed in claim 17, wherein each of said first flange and said second flange defines four electrodes thereof corresponding to said four coils, respectively, under condition that one of the primary coils and one of the secondary coils commonly rotate clockwise while the other of the primary coils and the other of the secondary coils commonly rotate counterclockwise; wherein input ends of the primary coils and output ends of the secondary coils are located at the first flange while output of the primary coils and input ends of the secondary coils are located at the second flange;
wherein on the first flange the electrodes of the input ends of the primary coils are space from each other larger than that between the electrodes of the output ends of the secondary coils, and on the second flange the electrodes of the input ends of the secondary coils are spaced from each other larger than that between the electrodes of the output ends of the primary coils.

19. The surface mounted pulse transformer as claimed in claim 18, wherein only said one of the primary coils and said one of the secondary coils extend across each other on the first flange, and only said other of the primary coils and said other of the secondary coils extend across each other on the second flange.

20. The surface mounted pulse transformer as claimed in claim 19, wherein all electrodes are equipped with electrode grooves to receive the corresponding ends of the coils, respectively.
